(19) United States
(12) Patent Application Publication
(10) Pub. No.: US 2016/0325124 A1
(43) Pub. Date: Nov. 10, 2016

(54) Particle-capturing device for removal of particles from respired air

(71) Applicant: Jonathan Dixon, San Diego, CA (US)

(72) Inventor: Jonathan Dixon, San Diego, CA (US)

(21) Appl. No.: 14/706,824

(22) Filed: May 7, 2015

(51) Int. Cl. A62B 23/02; A62B 18/02

(52) U.S. Cl. CPC A62B 23/025; A62B 18/02

(57) ABSTRACT

A particle-capturing device for insertion into the mouth of a user that incorporates a particle-capturing member that is capable or capturing particulate matter from the airflow of respired air.

### FIELD OF THE INVENTION

This invention relates to a particle-capturing device capable of attracting particulate matter from respired airflow.

### BACKGROUND OF THE INVENTION

In recent years it has become increasingly clear that particulate matter is contributing to a wider range of health-related concerns than previously thought. Due to the tendency of particulate matter to deposit on lung tissue, the impact of particulate matter as a contributor to conditions such as asthma and lung cancer are increasingly clear. Evidence suggests that the negative impact can even extend beyond respiratory functions into health concerns such as cardiovascular disease, birth defects and other types of cancer. The composition of particulate matter can vary, but can include sulphur dioxide, nitrogen oxides, carbon monoxide, mineral dust, organic matter and elemental carbon (also referred to as black carbon or soot). Particulate matter comprises both solid particles and liquid-like particles, with a significant portion of particulate matter comprising soot particles that largely consist of unburned carbon. A smaller portion of the combustion-related solid particles is comprised of inorganic material. Liquid-like particles are typically composed of a volatile mix of hydrocarbons, H₂SO₄, and H₂O with small amounts of inorganic species. Combustion-related particulate matter measures approximately between 5 and 2500 nm in diameter, with most particles measuring less than 200-300 nm in diameter. Particulate matter often comprises, or is at least partially covered with, carcinogenic polycyclic aromatic hydrocarbons (PAHs) and other volatile organic compounds (VOCs). These types of particulate matter are emitted into the air from the exhaust of combustion sources, such as automobile motors, and are formed as a result of an incomplete combustion process.

The health effects associated with particulate matter/air pollution have been demonstrated since the early 1970s. Particulate matter has been estimated to contribute to more than 50,000 deaths per year in the United States alone and contribute to air-pollution related health care costs estimated to be in excess of $150 billion per year. Individuals seeking to reduce or eliminate the intake of particulate matter outdoors, has very few options. The only option known to the inventor is a filter mask. Filter masks are placed over the airway of an individual and through either simple mechanical means or a combination of electro-mechanical operation, these masks seek to reduce or eliminate the intake of particulate matter. An air mask that relies solely on mechanical filtration is made of a mesh of dense fibers that are closely sufficient to capture micron-sized particulate matter. The density required for these masks presents significant impediments to airflow. Some masks, in order to enhance the filtration capability and increase airflow, make use of electret filter media. These masks use a combination of a mechanical function of a dense web of fibers along with an electret charge to achieve high filtration efficiency. Due to the properties of the electret, the mask fibers are able to be made less dense, thereby, initially, facilitating a decrease in airflow resistance. As the charged electret captures more and more particulate matter, the efficiency of the electret is reduced and the build-up of particulate matter enhances the mechanical filtration capability of the device. Over time, the net effect of this electro-mechanical mask will be an increase in airflow resistance similar to that of a the purely mechanical masks.

Notwithstanding any improvements in the filtration capabilities of a filter mask, these devices have significant drawbacks, especially for an individual engaged in a physical activity. The creation of airflow resistance created by these masks is a significant concern for anyone engaged in physical activity in that the mask significantly decreases the ability of the wearer to respire and intake the oxygen needed to enable continued exertion and performance. Additionally, these masks significantly increase the concentration of exhaled compounds that themselves can contribute to negative health effects (for example, increased levels of carbon dioxide (a significant component of exhaled air) can lead to drowsiness, unconsciousness, increased heart rate and blood pressure, and shortness of breath, among other effects).

There is, therefore, a need for a device which will reduce or eliminate the amount of inhaled particulate matter without impeding airflow during respiration.

### SUMMARY OF THE INVENTION

It is the object of this invention to provide a particle-capturing device capable of being inserted into the mouth of a user that is capable of capturing particulate matter entering the oral cavity from inhaled air in a manner that does not have a significant impact on inhaled or exhale airflow.

In a preferred embodiment, the particle-capturing device is in a form similar in size, shape and configuration to a mouthpiece, a mouth guard, or a retainer, and incorporating a particle-capturing member. In different embodiments, the particle-capturing member is incorporated into the device of the present invention in a variety of configurations, including across the teeth of a user or across the palate or part thereof of the user. In some embodiments, the particle-capturing member of the device is limited to only a portion of the device, while in other embodiments the entire device is made of the particle-capturing member.

In another embodiment of the invention, the particle-capturing member is a made of a porous, semi-porous or non-porous material and may include cavities sufficiently large to allow particulate matter to be collected therein. Additionally, the device could incorporate a thin removable film or cover positioned between the particle-capturing member of the device and the oral cavity such that particulate matter would collect thereon and the removable film or layer could be disposed of or cleaned for re-use. The device could also include a member positioned between the particle-capturing member and the palate to mediate the effects of the particle-capturing member in areas other than the oral cavity. The device could also include additives that enhance or magnify the properties of the particle-capturing member.

Those of skill in the art will recognize that the size, shape and configuration of the present invention can take various forms and embodiments, but that all such forms and embodiments are encompassed within the invention claimed herein. Additionally, those of skill in the art will recognize that the particle-capturing member described herein may be manufactured through a variety of processes, including new processes yet to be developed, and that a particle-capturing member of the present invention is not dependent on a specific manufacturing process. A particle-capturing member of the present invention would be covered regardless of manufacturing method. Additionally, those of skill in the art will recognize that the materials described herein are not limiting, but rather exemplary, and that the particle-capturing member of the present invention can be made from a number of different materials, provided it functions as described herein.

### BRIEF DESCRIPTION OF THE DRAWINGS

In the drawings:

FIG. 1. is a plain view of an embodiment of the invention looking from the top showing the arched particle-capturing member that is only a portion of the device.

FIG. 2. is a plain view of an embodiment of the invention looking from the bottom and showing the particle-capturing member embedded within the body of the device.

FIG. 3. is a section view taken along the vertical axis of the figure of FIG. 1 showing an insulating layer.

Like reference symbols in the various drawings indicate like element.

### DETAILED DESCRIPTION OF THE INVENTION

The particle-capturing member of the present device is preferably an electret. Electrets are materials that have a quasi-permanent electric field at their surface, due to either an imbalance of charge at the surface (space charge electrets) or to aligned dipoles through the materials (dipole electrets). Electrets fall within a larger class of materials known as dielectrics, which are materials that can be polarized by an applied electrical field, and can be found naturally, such as in quartz and silicon dioxide, or can be manufactured synthetically. Synthetically produced electrets are generally specially processed materials that retain an excess surface or internal charge in a frozen polarization creating a semipermanent external electric field. This electric field is the electrostatic equivalent of a magnet. Synthetically produced polymers such as fluoropolymers, polypropylene and polyethyleneterephthalate are examples of materials used for the production of an electret.

Synthetic electrets are manufactured through a variety of processes or treatments. One common process comprises heating a suitable dielectric material above its melting temperature and then cooling the material within a strong electric field. The strong electric field repositions the charge carriers or aligns the dipoles within the material and as the material cools, solidifies them in a fixed position. Electrets can also be manufactured through a process known as corona charging in which high voltage corona discharges are used to strand charges on the surface of a suitable dielectric material. Newer methods continue to be developed, including hydrocharging (e.g. see U.S. Pat. No. 5,496,507 (Angadjivand et al.) hereby incorporated by reference), a method in which a nonwoven web of thermoplastic conductive microfibers, capable of having a high quantity of trapped charge, is subjected to jets of water or a stream of water droplets at a pressure sufficient to transfer to the web excess charge, thereby creating an electret charge on the web. As discussed, the electret treatment may be any known treatment. Electret treatments are taught for example in U.S. Pat. Nos. 5,057,710, 5,556,618, 6,123,752, 6,743,464, 6,969,484, 6,284,339, 5,256,176 and 6,926,961, the disclosures of which are hereby incorporated by reference. The electret treatment is for example hydro-charging, tribo-electric charging or corona treatment.

One of skill in the art will recognize that the electret of the present invention can be manufactured through a variety of processes and the manufacturing thereof is not a limiting factor of this invention.

The electret of the present invention can be made from any number of materials and is only limited in that the material must have the ability to retain a charge sufficient to attract particulate matter from the airflow of respired air. The charge density of a material describes the measure of electric charge per unit of volume of space, either in one, two or three dimensions. For an electret of the present invention the charge surface and volume charge densities are of interest (two and three dimensions respectively). The total charge can be separated into “free” and “bound” charges. Bound charges are created in response to an applied electric field, E, that polarizes nearby dipoles in a linear fashion thereby resulting in an accumulation of charge. They are ‘bound’ because they cannot be removed. Free charges are excess charges which can move into electrostatic equilibrium, an example being the excess of surface charge on a balloon that results from the friction of the balloon surface against another material that transfer charge to the balloon which permits the balloon to be ‘stick’ to a wall or other surface. Over time, the excess charge is lost and the balloon surface moves back to an electrostatic equilibrium. Methods of calculating charge densities are known in the art, for example as described in I. S. Grant, W. R. Phillips (2008). Electromagnetism (2nd ed.). Manchester Physics, John Wiley & Sons. ISBN 9-780471-927129, hereby incorporated by reference.

In some embodiments, the electret could be made of a thermoplastic polymer, a non-conductive polymer that has the capability of possessing a non-transitory or long-lived trapped charge. For example, a polyolefin, a halogenated vinyl polymer (e.g. polyvinyl chloride), polystyrene, polycarbonate, a polyester (e.g. polyethylene terephthalate), a polyamide or a fluoropolymer (e.g. polytetrafluoroehulene).

Additionally, the electret could be polypropylene blend, a mixture of polypropylene with polyolefins, examples of which include, high density polyethylene (HDPE), high molecular weight high density polyethylene (HMW HDPE), ultra high molecular weight high density polyethylene (UHMW HDPE) medium density polyethylene (MDPE), low density polyethylene (LDPE), linear low density polyethylene (LLDPE), branched low density polyethylene (BLDPE) and ethylene-propylene-diene terpolymers (EPDM) containing small proportions of diene.

The device of the invention may be comprised entirely of a particle-capturing member or may, alternatively, be comprised of one or more particle-capturing members being incorporated into a device such that the particle-capturing member is facing the oral cavity or is otherwise positioned such that the particle-capturing member can influence the path of particulate matter in the respired airflow. For a device that includes members other than the particle-capturing member, such members could be made of materials suitable for use in an oral cavity and along the palate and could a member or members made from materials comprising plastics, metal, metal alloys, ceramics, composites, fibers, or other engineered materials.

In one embodiment, the particle-capturing member of the device of the present invention is made from polypropylene. The polypropylene is heated to its melting temperature, 266 degrees Fahrenheit (130 degrees Celsius). While in a liquid state, a high voltage electric discharge is applied to the liquid as it is allowed to cool. As cooling or once cooled, the polypropylene can be molded or cut into a desired shape.

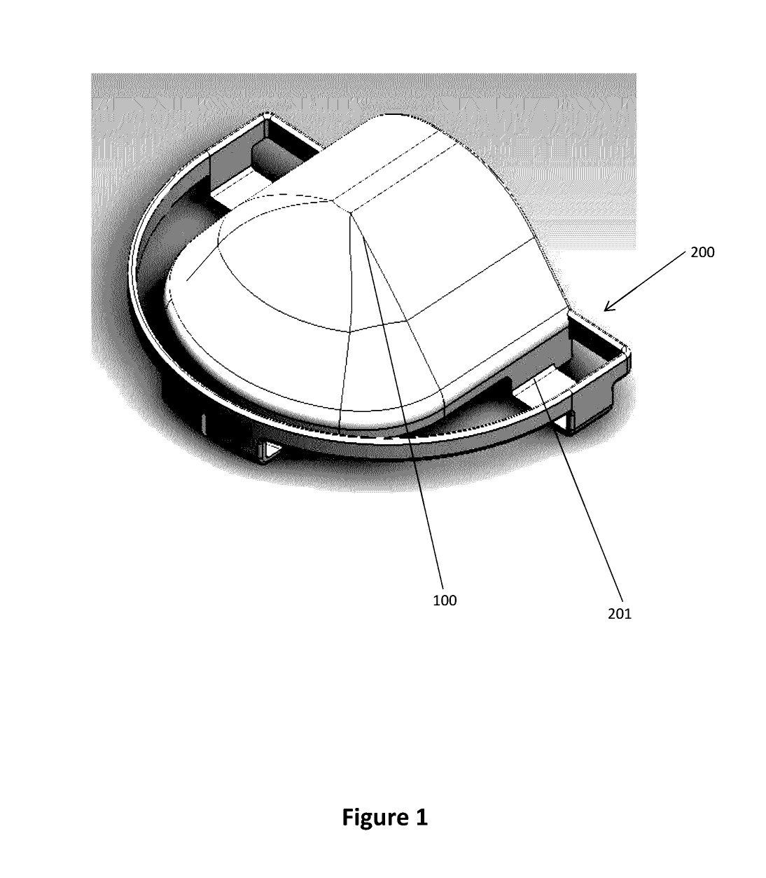

In an embodiment, as shown in FIG. 1, the device of the present invention could include a particle-capturing member 100 that is incorporated into, embedded within or part of the body 200 of the device. In FIG. 1, the particle-capturing member 100, could co-molded as part of the body 200, could be attached into place through a channel/groove configuration along the inner edge 201, could be snapped into place with the use of tab formed on the body 200 of the device and a detent on the particle-capturing member 100 (or vise-versa), or could be attached via an adhesive.

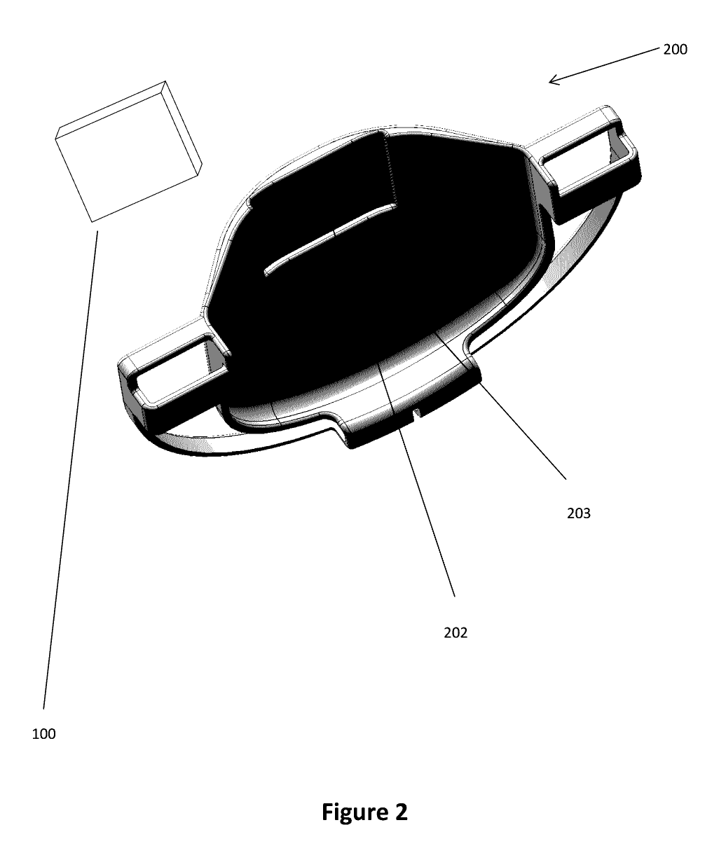

In another embodiment, as see in FIG. 2, the particle-capturing member 100 does not comprise the entirety of the palate portion of the device but is rather an member that can attach and detach from the body 200 of the device. Looking at the oral cavity facing surface 203 of the body 200 of the device, the particle-capturing member 100 is seen detached from the body and capable of being inserted into recess 202. The particle-capturing member 100 is seen covering only a portion of oral cavity facing surface 203, but in some embodiments the particle-capturing member 100 can cover all oral cavity facing surface 203 or only portion thereof and as one member or multiple members (not shown). Attachment of the particle-capturing member 100 to the body 200 of the device could be accomplished by any variety of mechanical or chemical means or mechanisms whether known or hereafter developed, and by example, but not by way of limitation, could include adhesive attachment, a channel/grove attachment or a snap attachment mechanism.

In an embodiment of the present invention, the particle-capturing member is made from ethylene-vinyl acetate (“EVA”). When compared to a material such as polypropylene, EVA is soft and flexible, thereby enabling the possibility of the device being made entirely of the particle-capturing member. EVA can more easily be shaped and molded into a desired form. An electret made from EVA can be manufactured in the same method described above, specifically heating the EVA to its melting temperature (250 degrees Fahrenheit (96 degrees Celsius), then applying a high voltage electric discharge and allowing the material to cool. An electret made of EVA can be molded into the shape of a mouthpiece such that the body 200 could be comprised entirely of a particle-capturing member 100, or similar to the example above, the particle-capturing member 100 made from EVA could be housed within a body 200. Other materials that could be suitable for use, include a low density polyethylene polymer and a polyolefin foam, however, the present invention is not limited to these materials.

Another aspect of the present invention could include a removable film or cover attached to the particle-capturing member 100 of the device. For example, in FIG. 2, the removable cover (not shown) could be placed over the particle-capturing member 100. The removable cover could be either disposable or reusable. The removable cover could be made of one or more parts and could cover the entire portion of the particle-capturing member 100 or a part thereof. The removable cover could itself be made of an electret material or could be a neutral material through which the electrostatic forces of the particle-capturing member 100 could work. The removable cover could be attached to the device through mechanical or chemical means. Mechanical attachment of the removable cover could be accomplished by the creation of grooves for insertion of the removable cover and/or tabs and a recessed portion of the bottom facing surface of the device, such that the removable cover could slide or snap into place. The removable cover could be attached to the device through an adhesive that would allow the removable covering to be reversibly attached to the bottom facing surface or could rely on the electrostatic attraction forces of the particle-capturing member to hold it in place. Once the removable cover has been saturated with particulate matter, or at the option of the user, it could be removed from the device and either disposed of or cleaned for re-use. Additionally, the removable cover could be attached solely through the electrostatic forces of the particle-capturing member.

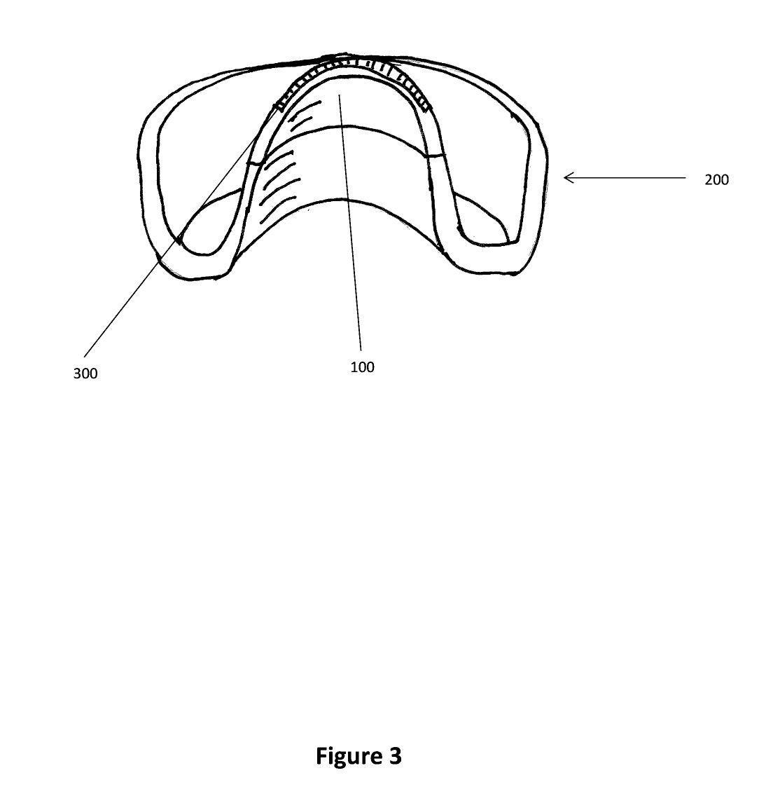

The device of the present invention could also include a means of mitigating the effects of the particle-capturing member 100 in areas outside the oral cavity. In FIG. 3, a device is shown incorporating a particle-capturing member 100, a body 200, and an insulating layer 300. For devices including an electret as the particle-capturing member, the means for mitigating the electrostatic effects of the electret could include the insertion of an insulating layer 300 between the electret and the palate. The insulating layer 300 would work to mitigate or eliminate the impact of the electrostatic forces of the electret in areas other than the oral cavity.

In certain instances the properties of an electret can be enhanced and/or improved by incorporating additives to the meld used to produce the electret. The introduction fluorchemicals into the meld used to produce the electret has been described in the literature (see, e.g., U.S. Pat. No. 5,025,052 (Crater et al.), incorporated herein by reference). U.S. Pat. No. 6,432,175 (Jones et al.), incorporated herein by reference, also describes an improved electret filter that incorporates fluorinated non-woven fibers in an effort to mitigate against the loss of filtering efficiency due to interference from certain contaminants, particularly oily liquid aerosols, that tend to cause electrets to lose their filtering efficiency (see e.g., U.S. Pat. No. 5,411,576 (Jones et al.)).

What is claimed is:

1. A particle-capturing device configured to remove particles from airflow within the oral cavity, said particle-capturing device comprising:
a particle-capturing member exposed to the interior of the oral cavity capable of capturing particulate matter from respired airflow.

2. The particle-capturing device of claim 1, further comprising:
an insulating layer incorporated between the particle-capturing member and the palate when worn by a user.

3. The particle-capturing device of claim 1, further comprising:
a removable cover attached to the particle-capturing member and positioned to face the oral cavity when worn by a user.
